(19) United States
(12) Patent Application Publication
(10) Pub. No.: US 2026/0322112 A1
(43) Pub. Date: Oct. 15, 2026

(54) SUPPLY CIRCUIT

(71) Applicant: STMicroelectronics International N.V., Geneva (CH)

(72) Inventors: Pascal Nonier, Saint-Ismier (FR); Julien Goulier, Grenoble (FR); Julien Mercier, Mimet (FR); Franck Montaudon, Meylan (FR); Marc Joisson, Brié et Angonnes (FR)

(21) Appl. No.: 19/575,011

(22) Filed: Mar. 23, 2026

(30) Foreign Application Priority Data
Apr. 11, 2025 (FR) FR2503916

(51) Int. Cl. H02J 1/08; H02J 50/20; H02M 3/07

(52) U.S. Cl. CPC H02J 1/084; H02J 50/20; H02M 3/07

(57) ABSTRACT

An example power supply circuit includes a first power source selection circuit and a second circuit. The first power source selection circuit is configured to receive power from a first power source and a second power source, where the second power source is different from the first power source. The first power source selection circuit is also configured to supply a first power supply voltage and a power source indication signal. The power source indication signal indicates which power source is supplying the first power supply voltage. The second circuit is configured to compare the first power supply voltage with either a first reference voltage or a second reference voltage. The selection of which reference voltage to use for the comparison is based on the value of the power source indication signal. When the first power supply voltage is greater than the first or second reference voltage, the first power supply voltage is supplied to the electronic device.

### CROSS-REFERENCE TO RELATED APPLICATIONS

This application claims priority to French Patent Application No. FR2503916, filed on Apr. 11, 2025, which application is hereby incorporated herein by reference.

### TECHNICAL FIELD

The present disclosure generally concerns electronic systems and devices, and in particular the power supply of such electronic systems and devices. The present disclosure more specifically concerns a power supply circuit adapted to receiving power from two different power sources.

### BACKGROUND

It is more and more common to be able to power an electronic device with a plurality of different power sources, such as for example a wired power source and a wireless power source.

The managing of a plurality of different power sources can lead to different constraints, which are generally managed by a power management circuit, or a power supply circuit.

It would be desirable to be able to improve, at least partly, certain aspects of power supply circuits adapted to receiving power from two different power sources.

### SUMMARY

An embodiment power supply circuit includes a first power source selection circuit and a second circuit. The first power source selection circuit is configured to receive power from a first power source and a second power source, where the second power source is different from the first power source. The first power source selection circuit is also configured to supply a first power supply voltage and a power source indication signal. The power source indication signal indicates which power source is supplying the first power supply voltage. The second circuit is configured to compare the first power supply voltage with either a first reference voltage or a second reference voltage. The selection of which reference voltage to use for the comparison is based on the value of the power source indication signal. When the first power supply voltage is greater than the first or second reference voltage, the first power supply voltage is supplied to the electronic device.

An embodiment electronic device includes a selection circuit and a comparison circuit. The selection circuit is configured to receive power from a first power source and a second power source, where the second power source is different from the first power source. The selection circuit is also configured to supply a first power supply voltage and a power source indication signal. The power source indication signal indicates which power source is supplying the first power supply voltage. The comparison circuit is configured to compare the first power supply voltage with either a first reference voltage or a second reference voltage. The selection of which reference voltage to use for the comparison is based on the value of the power source indication signal. When the first power supply voltage is greater than the first or second reference voltage, the first power supply voltage is supplied to the electronic device.

An embodiment method of powering an electronic device includes receiving, by a selection circuit, power from a first power source and a second power source, where the second power source is different from the first power source. The method also includes supplying, by the selection circuit, a first power supply voltage and a power source indication signal. The power source indication signal indicates which power source is supplying the first power supply voltage. The method further includes comparing, by a comparison circuit, the first power supply voltage with either a first reference voltage or a second reference voltage. The selection of which reference voltage to use for the comparison is based on the value of the power source indication signal. The method also includes supplying the first power supply voltage to the electronic device when the first power supply voltage is greater than the first or second reference voltage.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an embodiment of an electronic device comprising an embodiment of a power supply circuit;

FIG. 2 shows a practical example of embodiment of a portion of the embodiment of FIG. 1;

FIG. 3 shows a practical example of embodiment of another portion of the embodiment of FIG. 1;

FIG. 4 shows a practical example of embodiment of still another portion of the embodiment of FIG. 1; and

FIG. 5 shows a practical example of embodiment of still another portion of the embodiment of FIG. 1.

### DETAILED DESCRIPTION OF ILLUSTRATIVE EMBODIMENTS

Various embodiments described herein relate to higher-performance power supply circuits. Various embodiments described herein relate to higher-performance power supply circuits adapted to managing a plurality of power sources. Various embodiments described herein relate to power supply circuits adapted to managing a plurality of power sources which do not supply the same quantities of power. Various embodiments described herein relate to methods of powering electronic devices using such power supply circuits. Various embodiments described herein relate to devices comprising such power supply circuits.

An embodiment provides improvements over known power supply circuits. An embodiment provides improvements over known methods of powering electronic devices.

An embodiment provides a power supply circuit of an electronic device adapted to receiving power from a first power source and a second power source different from the first power source, said power supply circuit comprises: a first power source selection circuit adapted to receiving power from the first power source and the second power source, and to supplying a first power supply voltage and a signal indicating the power source supplying said first power supply voltage; and a second circuit adapted to comparing said first power supply voltage with a first reference voltage or a second reference voltage as a function of a value of said signal, if said first power supply voltage is higher than said first or second reference voltage, then said first power supply voltage is used for the powering of the electronic device.

Another embodiment provides a method of powering an electronic device adapted to receiving power from a first power source and from a second power source different from the first power source, using a power supply circuit comprising: a first power source selection circuit adapted to receiving power from the first power source and second power source, and to supplying a first power supply voltage and a signal indicating the power source supplying said first power supply voltage; and a second circuit adapted to comparing said first power supply voltage with a first reference voltage or a second reference voltage as a function of a value of said signal, if said first power supply voltage is higher than said first or second reference voltage, then said first power supply voltage is used for the powering of the electronic device.

According to an embodiment, the first power source is a wireless power source. According to an embodiment, the second power source is a wired power source. According to an embodiment, said first reference voltage is associated with the first power source. According to an embodiment, said second reference voltage is associated with the second power source. According to an embodiment, when said signal indicates that said first power supply voltage is supplied by the first power source, then the second circuit compares said first power supply voltage with said first reference voltage. According to an embodiment, when said signal indicates that said first power supply voltage is supplied by the second power source, then the second circuit compares said first power supply voltage with said second reference voltage. According to an embodiment, said power supply circuit further comprises a voltage regulator adapted to converting said first power supply voltage into a second power supply voltage. According to an embodiment, said second power supply voltage is lower than the first power supply voltage. According to an embodiment, said voltage regulator is adapted to receiving said signal and to modifying the value of the second power supply voltage according to the value transmitted by said signal. According to an embodiment, said power supply circuit further comprises a bandgap circuit adapted to supplying the first reference voltage and the second reference voltage.

Another embodiment provides an electronic device comprising an above-described power supply circuit.

According to an embodiment, the device further comprises a memory adapted to receiving said signal and comprising charge pumps having their operation modified by a value of said signal. According to an embodiment, the device further comprises a clock signal generator adapted to receiving said signal.

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and have been described in detail.

Unless otherwise specified, when reference is made to two elements being connected to each other, this means directly connected without any intermediate elements other than conductors, and when reference is made to two elements being coupled to each other, this means that these two elements may be connected or may be connected via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

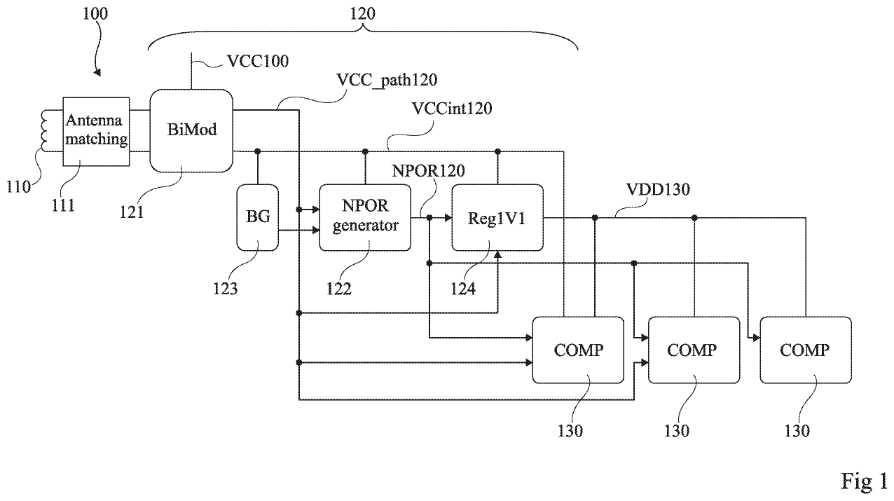

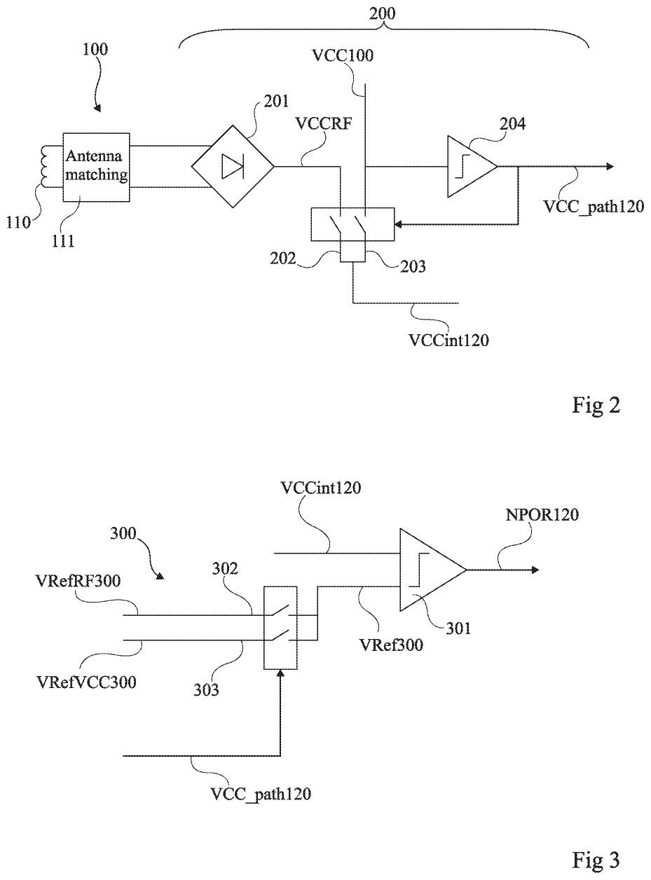

The embodiments described hereafter concern a power supply circuit for an electronic device adapted to being powered by two different power sources, such as, for example, a wired power source and a wireless power source. The embodiments described hereafter enable to manage different power sources which do not reliably supply the same power levels. For this purpose, the power supply circuit comprises a circuit adapted to verifying that a voltage level generated from these power sources is sufficient depending on the power source used. Such a power supply circuit is described in relation with FIG. 1, and practical examples of embodiment of some of these elements are described in relation with FIGS. 2 to 5.

Further, the embodiments described hereafter are particularly adapted to being used in the banking field, the identification field, for example for identity identifications based on the use of a passport or an identity card, the field of the Internet of Things, and the field of transportation.

Further, more generally, the above-described embodiments are particularly adapted to being used in any type of industrial market where a powering of an electronic device from a plurality of different power sources is used. More particularly, such a power supply circuit may be intended for:
the automotive industry, for example in the field of automotive electrification or in the field of advanced driver assistance systems (ADAS); the industrial sector, for example in the field of green energy, in the field of infrastructure electrification, of the Internet of Things (IoT) and smart homes, where electricity and energy consumption and data exchange are key elements; the personal electronics industry, for example in the field of mobile telephony and of the Internet of Things (IoT), as well as in the field of broadband interfaces; and the industry of communications equipment, computers, and peripherals, for example in the field of infrastructure and data centers, and in the field of low earth orbit (LEO) satellites.

FIG. 1 shows a portion of an electronic device 100 comprising an antenna 110, a power supply circuit 120, and one or more electronic components 130.

According to an embodiment, electronic device 100, and in particular its power supply circuit 120, is adapted to receiving power from a plurality of different power sources, for example at least two different power sources. These power sources may be wired power sources, for example coupled to the mains, internal power sources, for example a battery, wireless power sources, for example requiring the use of an antenna or of another wireless communication tool etc. Other types of power source may readily occur to those skilled in the art.

In the example shown in FIG. 1, device 100 is adapted to receiving power from a first wireless power source via antenna 110, and is adapted to receiving power from a second wired power source via a voltage VCC100 directly received by power supply circuit 120.

According to an example, device 100 comprises antenna 110 and an impedance matching circuit 111 (Antenna Matching) of antenna 110. In FIG. 1, antenna 110 is represented by a coil having its two terminals coupled, preferably connected, to two inputs of impedance matching circuit 111. According to a practical example, antenna 110 may be adapted, and in particular sized, for the implementation of a wireless communication using a radio frequency field, such as for example a near field communication (NFC).

According to an embodiment, the power supply circuit 120 of device 100 comprises a power source selection circuit 121 (BiMod) adapted to receiving power from the power sources of device 100. Thus, in the example shown in FIG. 1, selection circuit 121 is adapted to receiving power from antenna 110 and to receiving voltage VCC100 from the wired power source. Even more particularly, for this purpose, selection circuit 121 comprises two first inputs coupled, preferably connected, to outputs of the impedance matching circuit 111 of the antenna 110, and a second input adapted to receiving voltage VCC100. A practical example of embodiment of selection circuit 121 is described in relation with FIG. 2.

According to an embodiment, selection circuit 121 is adapted to delivering, at its output, an internal power supply voltage VCCint120 and a signal VCC_path120 indicating the power source supplying this power supply voltage. More particularly, signal VCC_path120 is adapted to indicating by a value that it transmits that voltage VCCint120 is supplied from the power of the first or second power source.

According to an embodiment, power supply circuit 120 comprises a circuit 122 (NPOR generator) adapted to receiving internal supply voltage VCCint120 and signal VCC_path120. According to an embodiment, circuit 122 is adapted to verifying the characteristics of internal power supply voltage VCCint120 and to comparing them with reference characteristics of the voltages supplied by the power sources of device 100. According to an example, circuit 122 is adapted to comparing the amplitude of power supply voltage VCCint120 with reference voltage amplitudes, taking into account the value transmitted by signal VCC_path120. A practical example of embodiment of circuit 122 is described in relation with FIG. 2.

More specifically, in the case shown in FIG. 1, if the value transmitted by signal VCC_path120 indicates that internal supply voltage VCCint120 originates from the wireless power source, then the amplitude of voltage VCCint120 is compared with a reference voltage VRefRF100 associated with the wireless power source. Similarly, and still in the case illustrated in FIG. 1, if the value transmitted by signal VCC_path120 indicates that internal supply voltage VCCint120 originates from the wired power source, then the amplitude of voltage VCCint120 is compared with a reference voltage VRefVCC100 associated with the wired power source.

According to an example, circuit 122 is adapted to delivering, as an output, a signal NPOR120 configured to indicate whether or not the characteristics of internal power supply voltage VCCint120 are compliant. According to an example, signal NPOR120 is adapted to transmitting a value indicating whether the characteristics of internal power supply voltage VCCint120 are compliant or not.

According to an example, power supply circuit 120 further comprises a bandgap circuit 123 (BG) adapted to supplying the various reference voltages necessary for the operation of circuit 122. According to an example, bandgap circuit 123 is adapted to receiving the reference power supply voltage and to supplying the reference voltages. More particularly, in the case illustrated in FIG. 1, bandgap circuit 123 is adapted to supplying reference voltages VRefRF100 and VRefVCC100 to circuit 122.

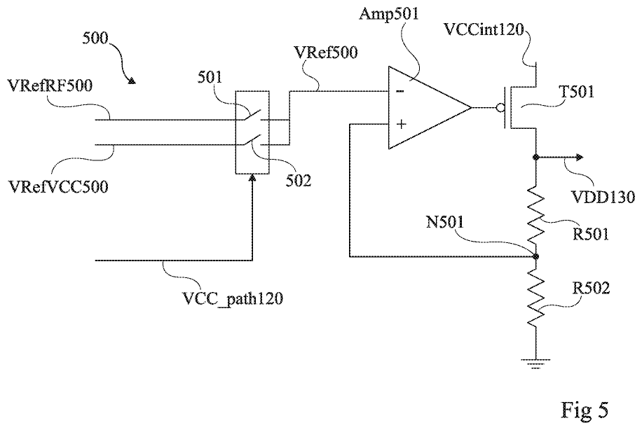

According to an example, power supply circuit 120 further comprises at least one voltage regulator 124 (Reg 1V1) adapted to receiving internal supply voltage VCCint120 and signal NPOR120, and to supplying a power supply voltage VDD130, for example lower than internal power supply voltage VCCint120, adapted to powering the components 130 of device 100. According to an example, the value transmitted by signal NPOR120 enables to authorize regulator 124 to operate. If device 100 requires a plurality of power supply voltages of different amplitudes, device 100 may comprise a plurality of voltage regulators of the type of voltage regulator 124. According to an embodiment, the voltage level of power supply voltage VDD130 may be variable depending on the selected power source. More particularly, voltage regulator 124 may receive signal VCC_path120 and modify the value of power supply voltage VDD130 as a function of a value transmitted by signal VCC_path120. A practical example of embodiment of voltage regulator 124 is described in relation with FIG. 5. Other practical examples of implementation of voltage regulator 124 are within the abilities of those skilled in the art.

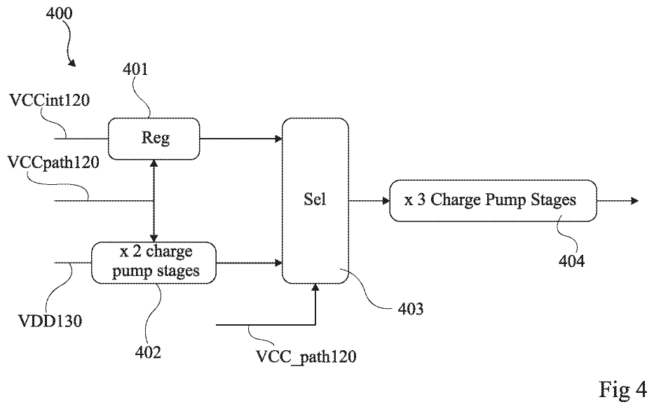

According to an example, device 100 comprises electronic components 130 (COMP) adapted to being powered by power supply circuit 120 and to receiving, according to cases, internal power supply voltage VCCint120 and/or a regulated power supply voltage such as, for example, power supply voltage VDD130. According to an example, some of, or all, electronic components 130 are adapted to receiving signals VCC_path120 and NPOR120 and to taking into account the values that they transmit. Some electronic components 130, such as for example memories or clock signal generators, can thus adapt their operation to the power source used by device 100. A specific example of a memory is described in relation with FIG. 4.

According to an embodiment, power supply circuit 120 operates as follows. This operation corresponds to a method of supplying power to device 100.

When wired power source is the only one available, device 100 is powered by this power source. In this case, selection circuit 121 supplies internal power supply voltage VCCint120 from voltage VCC100. Circuit 122 then verifies whether voltage VCCint120 is compliant by comparing it, for example, with reference voltage VRefVCC100, and then transmits this information to electronic components 130 and, if applicable, to voltage regulator 124.

When the wireless power source is the only one available, device 100 is powered by this power source. In this case, selection circuit 121 supplies internal power supply voltage VCCint120 from a voltage picked up by antenna 110. Circuit 122 then verifies whether voltage VCCint120 is compliant by comparing it, for example, with reference voltage VRefRF100, and then transmits this information to electronic components 130 and, if applicable, to voltage regulator 124.

When a plurality of power sources are available, device 100 can be powered by either one or the other. A selection is then performed based on priority rules. According to an example, a wired power source may always be used by default.

These embodiments are particularly useful to adapt the performance of device 100 by adjusting the operation of electronic components 130 according to the available power source, for example the wired power source or the power picked up by the antenna.

FIG. 2 shows a practical example of embodiment of a selection circuit 200 of the type of the selection circuit 121 described in relation with FIG. 1.

FIG. 2 also shows the antenna 110 and the impedance matching circuit 111 (Antenna Matching) of the device 100 described in relation with FIG. 1.

Selection circuit 200 is adapted to selecting a power source from the wireless power source and the wired power source described in relation with FIG. 1, and to supplying the internal supply voltage VCCint120 described in relation with FIG. 1.

According to an example, selection circuit 200 comprises a voltage rectifier bridge 201 adapted to receiving an AC voltage picked up by antenna 110. For this purpose, voltage rectifier bridge 201 comprises two inputs coupled, preferably connected, to the outputs of impedance matching circuit 111, and supplies, at its output, a rectified voltage VCCRF. According to an example, voltage rectifier bridge 201 is a diode bridge well known to those skilled in the art.

According to an example, selection circuit 200 further comprises two switches 202 and 203. These two switches are adapted to supplying internal power supply voltage VCCint120 from voltages VCCRF and VCC100. More particularly, switch 202 is adapted to receiving, on one of its conduction terminals, voltage VCCRF, and to supplying, on its other conduction terminal, voltage VCCint120. Similarly, switch 203 is adapted to receiving, on one of its conduction terminals, voltage VCC100, and to supplying, on its other conduction terminal, voltage VCCint120. The control terminals of the switches are adapted to receiving power source selection control signals. According to an example, the control signals of switches 202 and 203 are the signal VCC_path120 described in relation with FIG. 1. The technology and the sizing of switches 202 and 203 are accessible to those skilled in the art.

According to an example, selection circuit 200 further comprises a comparator 204 adapted to delivering, as an output, signal VCC_path120. According to an example, comparator 204 receives as an input voltage VCC100 and compares it with a threshold voltage. If voltage VCC100 is greater than the threshold voltage, then the wired power source is selected, otherwise the wireless power source is selected. According to a preferred example, the threshold voltage is an internal comparison voltage of comparator 204.

FIG. 3 shows a practical example of embodiment of a selection circuit 300 of the type of the circuit 122 described in relation with FIG. 1.

Circuit 300 is adapted to receiving voltage VCCint120 and to comparing it with reference voltages according to a value transmitted by the signal VCC_path120 described in relation with FIG. 1.

According to an example, circuit 300 comprises a comparator 301 adapted to comparing voltage VCCint120 with a reference voltage VRef300, and to deliver, as an output, the signal NPOR120 described in relation with FIG. 1.

According to an example, selection circuit 300 further comprises two switches 302 and 303 adapted to supplying reference voltage VRef300 from reference voltages VRefRF300 and VRefVCC300, which reference voltages are, for example, the reference voltages VRefRF100 and VRefVCC100 described in relation with FIG. 1, or are reference voltages supplied by a circuit of the type of bandgap circuit 123 described in relation with FIG. 1. More particularly, switch 302 is adapted to receiving, on one of its conduction terminals, voltage VRefRF300, and to supplying, on its other conduction terminal, voltage VRef300. Similarly, switch 303 is adapted to receiving, at one of its conduction terminals, voltage VRefVCC300, and to supplying, on its other conduction terminal, voltage VRef300. The control terminals of switches 302 and 303 are adapted to receiving control signals. According to an example, the control signals of switches 302 and 303 are the signal VCC_path120 described in relation with FIG. 1. The technology and the sizing of switches 302 and 303 are accessible to those skilled in the art.

FIG. 4 shows a practical example of embodiment of a portion of an electronic component 400 of the type of the electronic components 130 described in relation with FIG. 1.

According to an embodiment, electronic component 400 is a memory, and in particular, for example, a non-volatile memory. The portion illustrated in FIG. 4 is a portion for powering the memory comprising charge pump stages.

According to an example, portion 400 comprises a regulator 401 (Reg) adapted to receiving internal power supply voltage VCCint120 and signal VCC_path120.

According to an example, portion 400 further comprises first charge pump stages 402 (×2 charge pump stages) adapted to receiving the power supply voltage VDD130 described in relation with FIG. 1 and signal VCC_path120. Charge pump stages 402 are adapted to operating by being only powered with power supply voltage VDD130.

According to an example, portion 400 further comprises a selection circuit 403 adapted to receiving the output of regulator 401 and the output of first charge pump stages 402, and adapted to being controlled by signal VCC_path120.

According to an example, portion 400 further comprises second charge pump stages 404 (×3 charge pump stages) adapted to receiving an output voltage from selection circuit 403. Charge pump stages 404 are adapted to operating only when the output voltage of selection circuit 403 is higher than power supply voltage VDD130.

FIG. 5 shows a practical example of embodiment of a circuit 300 for selecting the type of circuit 122 described in relation with FIG. 1.

Voltage regulator 500 is adapted to receiving, as an input, internal power supply voltage VCCint120 and to delivering, as an output, the power supply voltage VDD130 described in relation with FIG. 1. The specificity of voltage regulator 500 is that it is capable of adapting the value of power supply voltage VDD130 according to the selected power source.

According to an example, regulator 500 further comprises two switches 501 and 502 adapted to supplying a reference voltage VRef500 from reference voltages VRefRF500 and VRefVCC500, which reference voltages are, for example, the reference voltages VRefRF100 and VRefVCC100 described in relation with FIG. 1, or are reference voltages supplied by a circuit of the type of the bandgap circuit 123 described in relation with FIG. 1. More particularly, switch 501 is adapted to receiving, on one of its conduction terminals, voltage VRefRF500, and to supplying, on its other conduction terminal, voltage VRef500. Similarly, switch 502 is adapted to receiving, on one of its conduction terminals, voltage VRefVCC500, and to supplying, on its other conduction terminal, voltage VRef500. The control terminals of switches 501 and 502 are adapted to receiving control signals. According to an example, the control signals of switches 501 and 502 are the signal VCC_path120 described in relation with FIG. 1. The technology and the sizing of switches 501 and 502 are accessible to those skilled in the art.

According to an example, regulator 500 further comprises a differential amplifier Amp501 and a switch T501. According to an example, switch T501 is a transistor, for example a metal-oxide-semiconductor field-effect transistor, or MOSFET transistor, or MOS transistor. Further, according to an example, transistor T501 is a P-channel MOS transistor, or P-type MOS transistor, or PMOS transistor. An inverting input terminal (−) of amplifier Amp501 is adapted to receiving reference voltage VRef500, and a second non-inverting input terminal (+) of the amplifier is coupled, preferably connected, to a node N501. An output terminal of amplifier Amp501 is adapted to controlling switch T501. A first conduction terminal of switch T501 is adapted to receiving internal power supply voltage VCCnt120, and a second conduction terminal of switch T501 is adapted to supplying power supply voltage VDD130.

According to an example, regulator 500 further comprises two resistors R501 and R502. A first terminal of resistor R501 is coupled, preferably connected, to the conduction terminal of the switch supplying power supply voltage VDD130, and a second terminal of resistor R501 is coupled, preferably connected, to node N501. A first terminal of resistor R502 is coupled, preferably connected, to node N501, and a second terminal of resistor R502 is coupled, preferably connected, to a node receiving a reference potential, for example ground.

Various embodiments and variants have been described. The person skilled in the art will understand that certain features of these various embodiments and variants could be combined, and other variants will become apparent to the person skilled in the art.

What is claimed is:

1. A power supply circuit comprising:
a first power source selection circuit configured to
receive power from a first power source and a second power source different from the first power source, and
supply a first power supply voltage and a power source indication signal indicating a power source supplying the first power supply voltage; and
a second circuit configured to compare the first power supply voltage with a first reference voltage or a second reference voltage as a function of a value of the power source indication signal; and
wherein when the first power supply voltage is greater than the first or second reference voltage, the first power supply voltage is supplied to an electronic device.

2. The circuit according to claim 1, wherein the first power source is a wireless power source.

3. The circuit according to claim 1, wherein the second power source is a wired power source.

4. The circuit according to claim 1, wherein the first reference voltage is associated with the first power source.

5. The circuit according to claim 4, wherein the second reference voltage is associated with the second power source.

6. The circuit according to claim 4, wherein in response to the power source indication signal indicating that the first power supply voltage is being supplied by the first power source, the second circuit compares the first power supply voltage with the first reference voltage.

7. The circuit according to claim 5, wherein in response to the power source indication signal indicating that the first power supply voltage is being supplied by the second power source, the second circuit compares the first power supply voltage with the second reference voltage.

8. The circuit according to claim 1, further comprising a voltage regulator configured to convert the first power supply voltage into a second power supply voltage.

9. The circuit according to claim 8, wherein the second power supply voltage is lower than the first power supply voltage.

10. The circuit according to claim 8, wherein the voltage regulator is configured to receive the power source indication signal and to modify a value of the second power supply voltage as a function of a value transmitted by the power source indication signal.

11. The circuit according to claim 1, further comprising a bandgap circuit configured to supply the first reference voltage and the second reference voltage.

12. An electronic device comprising:
a selection circuit configured to
receive power from a first power source and a second power source different from the first power source, and
supply a first power supply voltage and a power source indication signal indicating a power source supplying the first power supply voltage; and
a comparison circuit configured to compare the first power supply voltage with a first reference voltage or a second reference voltage as a function of a value of the power source indication signal, wherein when the first power supply voltage is greater than the first or second reference voltage, the first power supply voltage is supplied to the electronic device.

13. The device according to claim 12, further comprising:
a memory configured to receive the power source indication signal; and
charge pumps having their operation modified by a value of the power source indication signal.

14. The device according to claim 12, further comprising a clock signal generator configured to receive the power source indication signal.

15. A method of powering an electronic device, the method comprising:
receiving, by a selection circuit, power from a first power source and a second power source different from the first power source;
supplying, by the selection circuit, a first power supply voltage and a power source indication signal indicating a power source supplying the first power supply voltage;
comparing, by a comparison circuit, the first power supply voltage with a first reference voltage or a second reference voltage as a function of a value of the power source indication signal; and
supplying the first power supply voltage to the electronic device when the first power supply voltage is greater than the first or second reference voltage.

16. The method according to claim 15, wherein the first reference voltage is associated with the first power source, and wherein, in response to the power source indication signal indicating that the first power supply voltage is being supplied by the first power source, the comparing comprises comparing the first power supply voltage with the first reference voltage.

17. The method according to claim 15, wherein the second reference voltage is associated with the second power source, and wherein, in response to the power source indication signal indicating that the first power supply voltage is being supplied by the second power source, the comparing comprises comparing the first power supply voltage with the second reference voltage.

18. The method according to claim 15, further comprising converting, by a voltage regulator, the first power supply voltage into a second power supply voltage.

19. The method according to claim 18, further comprising modifying, by the voltage regulator, a value of the second power supply voltage as a function of a value transmitted by the power source indication signal.

20. The method according to claim 15, further comprising generating, by a bandgap circuit, the first reference voltage and the second reference voltage.
